(19) United States
(12) Patent Application Publication
(10) Pub. No.: US 2007/0079733 A1
(43) Pub. Date: Apr. 12, 2007

(54) Cementitious mix with fibers

(76) Inventor: David Crocker, Grand Prairie, TX (US)

Correspondence Address: Schultz & Associates, P.C., Suite 1200, 5400 LBJ Freeway, Dallas, TX, 75240, US

(21) Appl. No.: 11/247,930

(22) Filed: Oct. 10, 2005

(51) Int. Cl. C04B 18/06

(52) U.S. Cl. 106/711; 106/816; 106/724; 106/705

(57) ABSTRACT

A lightweight concrete composition comprising a dry mixture of an aggregate component, a hydraulic cement component and a fiber component. The aggregate component has a bulk density of 75 pounds per cubic foot or less and is present in the composition in an amount within the range of 55-70 wt. %. The hydraulic cement component is present in the dry mixture in an amount within the range of 30-45 wt. % and comprises three constituents. One constituent is selected from the group consisting of Type I and Type III cements and mixtures thereof. A second cement constituent, present in in an amount which is less than the first cement constituent, is a pozzolanic cement. The third cement constituent is present in an amount which is less than the amount of the second cement constituent and includes Type S masonry cement, Type N masonry cement, an air entraining agent and mixtures thereof. The fiber component can be Type AR glass fibers, having an aspect ratio within the range of 0.0015-0.005.

### FIELD OF THE INVENTION

This invention relates to dry lightweight cementitious compositions and processes for forming lightweight structural units and more particularly to such compositions incorporating fibers.

### BACKGROUND OF THE INVENTION

In the formulation of cementitious compositions, mixtures of different hydraulic cements, as well as other additives such as accelerators and retarders are used in order to provide such characteristics of setting times, strengths, and volume changes as are needed to meet the needs or demands of various specialty applications. Ready-to-use cement mixes may be sold in relatively small packages for convenient use in carrying out small jobs such as in minor repair and patching applications or for the setting of fence posts and similar such endeavors. By way of example, various ready-to-use cement mixes are marketed under the designation “SAKRETE” or “QUIKRETE” and others, in sacks having a volume of about 0.6 cubic feet and weighing about 80 pounds per sack—providing a bulk density of about 135-150 pounds per cubic foot (ppcf). Typically, such ready-to-use mixes are sold as concrete mix containing relatively coarse aggregates, and thus suitable for setting fence posts or the repair of driveways, sidewalks or the like to a thickness of 2 inches or more, and sand mix in which the aggregate component is of a much smaller size, suitable for patching with thicknesses less than 2 inches. Concrete mix and sand mix typically comprise a mixture of Portland cement, aggregate and sand. Another type of ready-to-use cement mix is mortar mix, which is useful in laying bricks, cement stepping stones or the like. Mortar mix normally is formed of masonry cement meeting ASTM (American Society for Testing and Materials) Designation C 91, usually Type N or S cement, mixed with various aggregates to meet specifications called for in ASTM Designation C 387 or C 270.

Cement and aggregate may be mixed in bulk and then mixed with water to form a concrete slurry, which is allowed to set to form the desired concrete structure. Glass fibers may be added in order to provide for reinforcement in the ultimate concrete structure. Typically, such fibers are added to a concrete formulation after the cement and aggregate components have been mixed with water to form the concrete slurry. For example, as disclosed in U.S. Pat. No. 5,916,361 to Molloy, after the aggregate and cement materials are mixed in a batching plant with water, the glass fibers are added gradually during mixing in order to form a uniform fiber dispersion.

The standards for lightweight aggregates suitable for use in structural concrete are set forth in ASTM C 330. Such aggregates intended for use in masonry units are set forth in ASTM C 331. Lightweight aggregates and lightweight concrete formulations made from such aggregates are described in “Lightweight Concrete,” published by the Expanded Shale, Clay and Slate Institute, Washington, D.C., October 1971. As described there under the heading “What is a Lightweight Aggregate?,” such aggregates can range from the so-called “super lightweights” which can be used in making concrete weighing 15 to 20 pounds per cubic foot to the natural aggregates, and finally to the expanded shale, clay and slate aggregates which can produce structural concrete ranging from about 85 to 115 pounds per cubic foot when produced by the rotary kiln method, and from about 90 to 120 pounds per cubic foot when produced by sintering. Structural lightweight concrete is described as having a 28 day compressive strength of at least 2,500 pounds per square inch and an air dry weight of no more than 115 pounds per cubic foot. Weights can be increased by replacing a portion of the lightweight aggregate with sand or normal weight coarse aggregate.

Lightweight cementitious products with glass fibers reinforcement are disclosed in U.S. Pat. No. 4,504,320 to Rizer et al. The Rizer et al. patent discloses a glass fiber reinforced cementitious product having a density of less than 85 pounds per cubic foot. Disclosed here is a mixture of Type III and Type I Portland cements with an aggregate component including fly ash, silica fume and microspheres. The silica fume is said to appear to have pozzolanic properties. The glass fiber component is added to a cement, aggregate and water mixture in an amount of at least 4 wt. %, preferably about 6 wt. %.

Relatively lightweight cementitious compositions are disclosed in U.S. Pat. Nos. 5,328,507 and 5,472,499 to Crocker. These cementitious compositions can be mixed with water to produce a paste that is easily workable and sets to produce a lightweight concrete unit structure of good compressive strength. The lightweight cementitious compositions disclosed in the Crocker patents comprise a dry mixture of a lightweight aggregate component and a hydraulic cement component. The aggregate component has a bulk density of no more than about 75 pounds per cubic foot and the hydraulic cement component can include several constituents including an air entraining agent providing an air entraining factor for the composition of at least 4 vol. % when the composition is mixed with water in an amount within the range of 21-23 wt. % of the dry mixture. The formulation can be further characterized in terms of a slump loss at ½ hour of not more than 2 inches after being mixed with water in an amount of 21-23 wt. %, and a concrete strength at 28 days after mixing with water of at least 2,500 psi. The hydraulic cement component can incorporate three commercially available cement constituents. One constituent is a masonry cement conforming to ASTM Standard C 91. A second constituent is a pozzolanic cement meeting ASTM Standard C 595 or an expansive cement meeting ASTM Standard C 845, and a third constituent is a Type I cement, Type II cement or a Type III cement meeting ASTM Standard C 150.

The aggregate component in the dry mixture comprises a lightweight aggregate present in an amount to provide a bulk density for the dry mixture of no more than 100 pounds per cubic foot, and more specifically about 85 pounds per cubic foot or less. The aggregate component can be characterized as meeting standards as specified in ASTM C 330 for structural concrete and ASTM C 331 for masonry concrete.

### SUMMARY OF THE INVENTION

In accordance with the present invention, there is provided a lightweight concrete composition comprising a dry mixture of an aggregate component, a hydraulic cement component and a fiber component. The aggregate component has a bulk density of 75 pounds per cubic foot or less and is present in the composition in an amount within the range of 55-70 wt. %. The hydraulic cement component is present in the dry mixture in an amount within the range of 30-45 wt. % and comprises three constituents. One constituent is selected from the group consisting of Type I and Type III cements and mixtures thereof. A second cement constituent is present in the mixture in an amount which is less than the amount of the first cement constituent. The second cement constituent is a pozzolanic cement and more specifically is selected from the group consisting of fly ash, Type C and Type F cement and mixtures thereof. The third cement constituent is present in an amount which is less than the amount of the second cement constituent. This third cement constituent is selected from the group consisting of Type S masonry cement, Type N masonry cement, an air entraining agent and mixtures thereof. The fiber component comprises fibers, preferably Type AR glass fibers, having an aspect ratio within the range of 0.0015-0.005 and more specifically within the range of 0.0014-0.007. The fiber component is present in an amount providing a glass fiber equivalent weight percent of 2 wt. % or less, and preferably is present in an amount of no more than 1 wt. % of the concrete composition. A more specific fiber content is 0.7 wt. % or less. Preferably, the fiber component is present in an amount of at least 0.3 wt. %.

In a more specific embodiment of the invention, the fiber component is present in an amount within the range of 0.4-0.7 wt. % and the aggregate component is comprised predominantly of haydite. The aggregate component preferably has an average particle size of 0.5 inch or less.

In a further aspect of the invention, the second cement constituent is present in the mixture in an amount within the range of 70-90 wt. % of the first cement constituent and the third cement constituent is present in an amount within the range of 10-20 wt. % of the first cement constituent. Desirably, the incremental amount between the amount of the first cement constituent and the second cement constituent is less than the incremental difference between the amount of the second cement constituent and the third cement constituent. More preferably, the difference between the second and third cement constituents is at least three times the incremental difference between the first and second cement constituents. More specifically, the composite amount of the second and third cement constituents is within ±10% of the amount of the first cement constituent. In a preferred embodiment, the first, second and third cement constituents are present in fractional amounts of 0.5, 0.4, and 0.1, respectively, of the hydraulic cement component. In a further embodiment of the invention, the third cement constituent comprises an air entraining agent which provides an air entraining factor of at least 4 vol. % when the dry composition is mixed with water in an amount within the range of 21-23 wt. % of the dry mixture.

In another aspect of the invention, there is provided a method of forming a fiber-reinforced concrete structure. In carrying out the method, a cementitious composition comprising an aggregate component and a hydraulic cement component as described above is provided. The cementitious composition further comprises a fiber component comprising Type AR glass fibers having an aspect ratio within the range of 0.0014-0.007, which is present in an amount of 0.7 wt. % or less of the concrete composition, with the glass fibers being predominantly covered with the hydraulic cement component. The cementitious composition is mixed with water to provide a cementitious slurry in which the glass fibers are dispersed predominantly within the hydraulic cement component as the hydraulic cement is hydrated with water. The cement slurry is then applied to a suitable working site and allowed to set to provide a structural mass in which the glass fibers are entrained within the structural mass. In a more specific embodiment of the invention, the cementitious slurry contains entrapped air in an amount which is greater than the entrapped air which would be contained within a corresponding slurry of the aggregate component and the cement component, but without the presence of the glass fiber component.

### DETAILED DESCRIPTION OF THE INVENTION

The present invention provides a lightweight concrete composition incorporating fibers, preferably glass fibers, in the form of a dry mixture which can be packaged in dry form in relatively lightweight bags, e.g., about 50 pound bags, or in bags weighing up to about 80 pounds and which can be mixed with a defined amount of water to produce a cementitious slurry or paste in plastic form which is readily workable, provides little or no slump loss within a customary working time of about 30 minutes and which produces a lightweight structural concrete meeting certain minimum standards. Upon mixing with water in a defined amount, usually about one gallon and one pint of water per bag containing a nominal concrete content of about 50 pounds, the resulting concrete product complies with standards as set forth in ACI (American Concrete Institute) Standards 211.2 and 213. That is, the resulting concrete product has a minimum compressive strength at 28 days (7 days wet cure and 21 days air cure at 50% relative humidity) of at least 2,500 pounds per square inch and a 28 day air dry density of no more than 115 pounds per cubic foot under the above-specified curing conditions. As a practical matter, substantially lower densities can be achieved without sacrificing strength and workability characteristics. Specifically, 28 day air dry densities of about 100 pounds per cubic foot or slightly less can be achieved with formulations of the present invention. The formulation of the present invention is air entraining and thus provides good durability in freezing and thawing environments, as well as in marine applications. A preferred formulation has an air entraining factor of 4-8 vol. % air when mixed with water in the range of 21-23 wt. % of the dry mixture. By virtue of the air entrainment after mixing with water, the resulting product has good workability for finishing and the air entrainment also lowers the unit weight and water demand.

The air entraining factor and other factors involved in the present invention such as concrete strength and slump loss are determined for slurries resulting from water mixed at 21-23 wt. % of the dry mixture in order to provide an objective standard for comparison at a water content within the range at which the water will normally be added to the dry mixture, normally at weight ratios of dry cementitious mixture to water within the range of 4:1-5:1 as described hereinafter. However, it is to be recognized that in some instances, other amounts of water may be used. For example, where very porous lightweight aggregate is involved, greater quantities of water may be used although usually at the price of lower strengths of the resulting concrete structural unit. Even then, the weight ratio of cement and aggregate to water will be about 3:1 or more, ranging up to an upper limit of about 5:1.

The concrete composition embodying the invention comprises a dry flowable mixture of a multi-constituent hydraulic cement component, lightweight aggregate component and a fiber component. The cement component comprises a mixture of two cement constituents and a third Portland cement constituent or an air entraining agent. The composition may also include water reducing normal set, water reducing set retarding, and accelerating admixtures conforming to ASTM Standard C 494 and plasticizing admixtures conforming to ASTM Standard C 1017. The fiber component preferably is in the form of Type AR glass fibers in an amount of about 2 wt. % or less and more specifically 1 wt. % or less.

Portland cements are characterized by type in accordance with standards developed and applied by the American Portland Cement Association and the standards and designations applied there are used in characterizing Portland cements herein. Such standards are based in large measure on standards and specification developed by the American Society for Testing and Materials (ASTM). For a description of the various examples of Portland cements and their applications, reference is made to Kosmatka et al. “Design and Control of Concrete Mixtures,” Fourteenth Edition, Portland Cement Association, and particularly Chapter 2, “Portland, Blended, and other Cements,” pp. 21-35.

As will be recognized by those skilled in the art, the air present in concrete mixtures can be characterized as entrapped air and entrained air. As explained in Chapter 8 of the aforementioned Design and Control of Concrete Mixtures by Kosmatka et al, entrained air, unlike entrapped air voids, which are largely a function of aggregate characteristics, are small in size and of a relatively regular shape. Thus, as stated at page 129 of Kosmatka et al, entrained air bubbles are about 10-1,000 micrometers in diameter and usually between 10-100 micrometers in diameter. Entrapped air, on the other hand, is usually somewhat irregular in shape and of a substantially larger size, usually having at least one dimension of one millimeter or larger. The total air content of a concrete slurry thus includes both entrained air and the somewhat larger dimensioned entrapped air. The entrapped air will usually be present in an amount of ½-3 vol. % and may be present in substantially larger amounts where extremely porous lightweight aggregates are employed. For example, expanded shales, aggregates generally characterized as haydite, which can include stack and dust collector dust circulated back into the expanded shale and clay particles, can contain substantially larger quantities of entrapped air ranging up to about 6-10 vol. % or even more. In fact, it is possible for a slurry incorporating some lightweight aggregates to contain a volume of entrapped air which is as much and sometimes even more than the volume of entrained air.

As noted previously, the invention involves a plurality of cement constituents mixed together. A first cement constituent which preferably is used in formulations embodying the present invention is a Type I/II cement which satisfies the specifications of both Type I and Type II cement or a high early strength cement characterized by Type III Portland cement as described in the aforementioned Chapter 2 of Kosmatka et al. Cements of the high early strength type and other types of Portland cement are composed of four principal compounds. These compounds (with the conventional cement chemistry abbreviated notations given in the parentheses) are tricalcium silicate, 3CaOSiO₂ (C₃S), dicalcium silicate 2CaOSiO₂ (C₂S), tricalcium aluminate, 3CaOAl₂O₃(C₃A), and tetracalcium aluminoferrite, 4CaOAl₂O₃Fe₂O₃ (C₄AF). The chemical composition of these cements, in terms of weight percent of oxides, is typically about ⅔ CaO, about ¼-⅕ silica, about 3-7% alumina, and usually lesser amounts of Fe₂O₃, MgO and SO₃. Thus, these Portland cement compositions typically contain more than 60% CaO and less than 3% aluminum and 1.5% sulfur. In terms of the cement chemistry notations described above, Type III cement typically contains in weight percent 56% C₃S, 19% C₂S, 10% C₃A and 7% C₄AF. The Type III Portland cement is ground to a very fine size which provides for high compressive strengths within a few days. For example, conventional Type III cement has a one day compressive strength of close to 2,000 psi and a 3-day compressive strength of about 3,500 psi (which is near the maximum). Type IIIA Portland cement, substantially identical to regular Type III in composition and fineness but containing an air entraining agent, has a one day compressive strength of about 1,500 psi.

Type I or Type II Portland cement can be used in place of or in combination with Type III cement. Type I Portland cement is substantially identical to Type III in terms of the contents of C₃S, C₂S, C₃A, and C₄AF, as described above, but is ground to a substantially coarser size and has a substantially low compressive strength at three days, about 1,800 psi and 1,500 psi for Type I and Type IA, respectively. Type II Portland cement, which is a sulfate resistant cement, is lower in C₃S and C₃A content than the Type I and Type III cements, but has higher C₂S and C₄AF contents. Type II cement has an even lower 3 day compressive strength than Type I. Type I/II cement which has the fineness of Type I cement and the chemistry of Type II cement can be employed.

The second cement which can be used as one of the three constituents in the cement component of the present invention is fly ash or another pozzolan-containing cement. Pozzolans are siliceous or aluminosiliceous materials which, as described in ASTM C 618, possess little or no cementitious value but react in finely divided form with water and calcium hydroxide to form compounds having cementitious properties. Pozzolans are derived from clays, diatomaceous earths, cherts, shales, pumicites and volcanic ashes. Pozzolan cements are described in Chapter 3 of Kosmatka et al. Pozzolan-type cements contain between 15 and 45% pozzolan. Pozzolan can be further classified by the designations Class N, Class F, and Class C. Class N is a raw or calcined natural pozzolan. It includes diatomaceous earth, opaline cherts, and shales, slates and selected clays, tuffs and volcanic ashes or pumicites. Class F is fly ash produced from burning anthracite or bituminous coal and Class C is fly ash produced from lignite or subbituminous coal. As described in Kosmatka et al. at page 58, fly ash type materials are usually solid spheres, though some are hollow cenospheres. They range in size from about one micron to more than 100 microns. The pozzolan-containing cement can be a cementitious material meeting ASTM C 595 or alternatively, it can be provided by combining a cement which, in itself, does not contain pozzolan, e.g., a cement meeting ASTM C 150 such as Type I cement, with a pozzolanic material such as covered by ASTM C 618. Thus, one can mix a Type I cement with pozzolan without milling to arrive at a suitable pozzolan-containing cement.

A third cement constituent in the hydraulic cement component is a masonry cement, specifically Type S cement or Type N cement, or an air entraining agent. The standard specifications for masonry-type cements are set forth in ASTM C 91. Type S masonry cement usually will be preferred, followed by Type N and then by Type M. Type S cement has a strength intermediate Type M, which is a relatively high strength masonry cement, and Type N which is a relatively low strength masonry cement. In most of the cementitious compositions formulated in accordance with the present invention, this constituent will be present in an amount within the range of 5-15 wt. %.

The fibers which are employed in the present invention preferably are glass fibers, specifically alkaline-resistant glass fibers, referred to as Type AR glass fibers. However, as described below, other synthetic fibers such as nylon fibers, or polyolefin fibers such as polyethylene or polypropylene fibers, or even steel fibers may be employed in lieu of, or in addition to the glass fibers. The glass (or other) fibers preferably range in length from about ¼ inch to 1 1/2/ inch. The average length of the glass fibers may vary depending upon the aggregate size. Where relatively large aggregate is employed, for example, ¾ inch aggregate, the fiber component may take the form of 1½ inch fibers. Aggregates of smaller particle size will usually, however, employ glass fibers having a length within the range of ½ to ¾ inch. Suitable glass fibers for use in the present invention are available from Nippon Electric Glass America, Inc. under the product designation ACS13H-530X and Saint-Gobain Vetrotex America under the designation Semfill Anticrak HD fibers and identified as W-70 chopped strands. The glass fibers are present in an amount of 2 wt. % or less of the lightweight concrete composition. Preferably, the fiber component is present in an amount of no more than 1 wt. % of the concrete composition and more specifically, in an amount within the range of 0.3-0.7 wt. % of the concrete composition.

As noted previously, other synthetic fibers may be employed in carrying out the present invention. Specifically, such fibers include fibers formed of thermoplastic polymers such as polyamide polymers (nylon) and polypropylene fibers formed of isotactic or syndiotactic polypropylene. Suitable nylon fibers for use in the present invention are available from Nycon Inc., Westerly, R.I., and suitable polypropylene fibers are disclosed in U.S. Pat. No. 6,248,835 to Gownder et al. The fibers are chopped to the desired length.

The weight concentration ranges described above for the type AR glass fibers will apply also with respect to the synthetic polymer fibers, such as nylon or polypropylene fibers. However, where steel fibers are employed, somewhat higher weight ranges will apply because of the higher density of steel, to provide the same amount of fiber component on a volumetric basis. The amount of fiber component employed in the present invention can be described in terms of the glass fiber equivalent weight where a high density fiber such as steel is employed, to take into account the higher specific gravity of the steel fibers. By the term “glass fiber equivalent weight percent” as used herein with respect to relatively heavy fibers such as steel fibers, it is meant the weight percent of the heavier fibers which provides the same volume of designated weight percent of glass fibers. For example, the weight percent of steel to provide the volume of steel fibers equivalent to 0.6 wt. % glass fibers would be approximately 1.6 wt. % to take into account the ratio of the specific gravity of steel to the specific gravity of the glass fibers.

The aggregate component is present in an amount in excess of the amount of the cement component, and more specifically in an amount within the range of 55-70 wt. % with the total cement content within the range of 30-45 wt. %. Preferably, the cement component will be present in an amount within the range of 34-42 wt. % and the aggregate component in an amount within the range of 58-66 wt. %. The aggregate component normally takes the form of rotary kiln expanded shale, termed haydite.

The lightweight materials used as aggregate in the cementitious composition preferably will have a bulk density within the range of 50-60 pounds per cubic foot (ppcf) and can be characterized as conforming to ASTM C 330, where strength is important because of structural considerations, or ASTM Standard C 331, where masonry applications are contemplated. Where very fine aggregate is employed, the bulk density may range up to about 75 ppcf. In some cases, e.g., where larger sized aggregate particles are involved, the bulk density may be below 50 ppcf down to about 40 ppcf. Preferably, the aggregate component normally will have an average particle size of ⅜ inch or smaller. As a practical matter, the aggregate will have a particle size distribution with a predominant portion passing a No. 4 sieve and more preferably passing a No. 8 sieve. Relatively small amounts of higher density normal weight aggregate material, such as sand, may be incorporated into the formulation where a somewhat denser product is desired, but usually the aggregate component will contain little, if any, sand or similar density coarse aggregate materials. For example, where the formulation contains a very fine aggregate, the bulk density of the aggregate may range up to about 75 ppcf, as described above. Little, if any, sand or similar aggregate material will be present in order to ensure that the bulk density of the cement-aggregate formulation will not exceed one hundred pounds per cubic foot. Where coarser light-weight aggregate is employed, the bulk density will be less and greater amounts of sand can be used. The character of the aggregate will depend, to some extent, on the relative amounts of aggregate and cement, but, in any event, the aggregate should be used in an amount to provide a bulk density of the dry mixture of no more than about 100 pounds per cubic foot. Usually it will be preferred to provide a bulk density of the dry mixture of cement and aggregate of no more than about 85 pounds per cubic foot, more specifically about 75 pounds per cubic foot. This will enable packaging of the product as a standard size bag of ready-to-mix concrete weighing about 45-50 pounds.

As noted previously, the fiber component is present in the dry mixture before hydration rather than first forming a slurry and then adding fibers to the slurry. The fiber component preferably is added to one of the aggregate components and the cementitious component prior to the mixing of these two components together to form the dry mixture. Preferably, the fiber component is added to the cement component concomitantly with or subsequent to the mixing of the cement constituents together to form the hydraulic cement component. This facilitates providing for the glass fibers being predominantly covered with the hydraulic cement component as is preferred in carrying out the invention. Alternately, however, the fibers can be mixed with the aggregate component and the aggregate component with the fibers therein then added to the blender with the hydraulic cement component.

In use, the dry cementitious composition of the present invention is mixed with water to provide a workable slurry having a density within the range of about 95-105 ppcf. The water content may vary somewhat depending upon the nature of the hydraulic cement component as described herein, but the water normally is added in an amount to provide a weight ratio of cement and aggregate to water within the range of 4:1-5:1.

The composition of the present invention can be formulated to provide very low slump loss rates during normal working times. In the preferred embodiment, the slump loss at one-half hour after the addition of water is not more than two inches at 72° F. when the mixture is mixed with water in an amount within the range of 21-23 wt. % of the dry mixture. Usually a one half hour slump loss of about one inch or less at 72° F. is provided. By way of example, a product formulated in accordance with the present invention, upon addition of water in an amount of about 22% of the dry mixture with 5% air entrainment, had a measured slump at three minutes after mixing with water of about five inches. At thirty minutes after mixing, the measured slump was four inches, i.e., a slump loss of only one inch. As will be understood by those skilled in the art, slump testing is carried out in accordance with ASTM Standard C 143. For a further description of the testing of freshly made concrete, including slump tests, reference is made to Kosmatka et al., Chapter 16, entitled “Control Tests for Quality Concrete,” at pp. 275-285.

Although the Portland cement component can be formulated from one or two cement constituents and an air entraining agent, it usually will be preferred to provide a formulation containing three cementitious constituents. The third, as described previously, is preferably Type S masonry cement. Type N cement can be substituted for the Type S masonry cement. In some cases, the higher strength Type M cement can be employed in lieu of the Type S cement. The Type S masonry cement provides fine cement particles, an air entraining agent, and finely ground limestone particles and dust, which usually will work to advantage in the formulation of the present invention. The Type S cement provides cement and limestone fines that function to block the pores in the lightweight aggregate which tend to absorb water, thus decreasing and slowing water absorption into the aggregate. In a similar vein, the cement also provides calcium silicate gel which tends to plug the pores and crevices in the lightweight aggregate. The air entraining agent causes the formation of small air bubbles that tend to block or fill the void spaces and crevices in the lightweight aggregates. These three activities function together to retard the absorption of water by the lightweight aggregate. In addition, when the cement formulation containing the Type S cement is hydrated, calcium hydroxide is formed, as is the case generally for Portland cements.

Calcium hydroxide formation is significant since it can be involved in several reactions leading to good long term strength. It also enables fly ash, which may be present in the composition from several sources, to react quickly. The fly ash also helps to block water absorption by the aggregate. The air entraining agent, or more properly the small air bubbles formed in the formulation, also acts to improve workability of the cement slurry and aids in finishing. It also contributes to a good freeze-thaw resistance.

In one embodiment of the present invention, the second cement constituent is Type IP cement and the first is Type III cement. The first constituent, Type III in the formulation under consideration here, is used in an amount approximately equal to the sum of each of the third cement constituent, Type S, and the second cement constituent, Type IP. Stated otherwise, the preferred ratio of the first constituent to the sum of the second and third constituents is about 1:1.

As described below, these concentrations can vary somewhat, but as a practical matter, the second cement constituent is present in amounts within the range of 70-90 wt. % of the first cement constituent, and the third within the range of 10-20 wt. % of the first constituent. The first, high early strength, cement constituent is present in an amount within the range of 40-60 wt. %. The Type III cement acts in conjunction with the Type S cement to provide good strength characteristics as the cement sets. The Type III, as noted earlier, provides good early strength. This helps to boost the somewhat lower, but still adequate, strength contribution of the Type S masonry cement. When the strength characteristics of these two cement constituents are compared, the contribution made by Type S is low and continuous, whereas the strength contribution of the Type III cement is fast and high. Type IP cement, which can be used as the second cement constituent, is inbetween the Type S and Type III cements. The strength gains associated with the Type S cement range from about 2 or 3 days to about 28 to 35 days. The Type IP cement ranges in strength gains from about 3 days to about 90 days, whereas the Type III cement achieves good strength in one day and reaches its maximum strength in about 7 to 14 days.

As noted previously, calcium hydroxide is produced with the addition of water from the Type S cement and this holds true for the Type III cement as well. The fly ash content present in the pozzolan-containing cement reacts with the calcium hydroxide to form calcium silicate, i.e., C₃S and C₂S in cement chemistry notation. The Type III cement, because it is a faster acting cement than the other constituents, produces calcium hydroxide faster than the Type S cement or the Type K cement. As a result, the fly ash in the Type IP cement is subject to a faster reaction than if it were reacting solely with the Portland cement (Type II clinker) in the IP constituent. The fly ash particles and the subsequently produced gel also help control slump loss and contribute to strength gain.

The Type S and Type IP cement constituents also act to balance one another in air entrainment by the final mixture. The Type S cement provides for air entrainment, whereas the fly ash content in the Type IP tends to de-train air from the mixture. The fly ash carbon content tends to absorb the air entraining agent. The amounts of Type IP and Type S cements can be adjusted to get the proper amount of entrained air, normally 4 to 8 vol. % air when the dry mixture is mixed with about 21 to 23 wt. % water. While air entrainment is highly desirable in terms of workability and durability (freeze-thaw characteristics and impermeability) of the hardened concrete, the amount of entrained air should also be limited since it functions to decrease compressive strength at the higher ranges of about 4,000 psi and above. Thus, it is preferred to provide the entrained air in an amount within the range of 4-8 vol. % in order to provide compressive strengths of about 4,000 psi and above. However, somewhat lower compressive strengths are sometime acceptable, although it is preferred to provide a 28-day compressive strength of at least 2,500 psi. Compressive strengths of this level can be achieved with an entrained air content substantially in excess of 8 volume percent up to about 12 volume percent or even more. However, while these higher entrained air values are acceptable, they are usually unnecessary in terms of providing good workability and durability characteristics.

Lightweight aggregate of the type employed in the present invention has a high water absorption rate. As a result, lightweight concrete mixes containing such aggregate have suffered from high slump loss rates becoming, for practical purposes, unworkable within unacceptably short time after mixing with water. Formulations embodying the present invention can be tailored in the relative amounts of constituents to arrive at the desired properties of the final product including a low slump loss as described herein. Once the relative amounts of the pozzolan and the masonry cement to be used in the composition are determined, a balance can be achieved with an adequate amount of Type I/II or Type III, which functions as a major strength contributor to the formulation. Empirical determinations can be made in which appropriate tests are carried out with incrementally increasing amounts of the first cement constituent for a given masonry and pozzolan mixture to arrive at a formulation which is suitable in terms of slump loss, workability, finishability, durability, strength and unit weight. The desired formulation will, as indicated by the aforementioned slump loss rate of two inches or less, hold its slump for suitable periods of time so that it can be worked in much the same manner as the normal heavier ready-to-use concrete mixes. If the relative amount of Type I/II or Type III cement is too small, the formulation could produce a concrete of inadequate compressive strength. The cement content should be such as to provide good workability and finishability.

In some applications, Type I or Type II Portland cement can be used instead of the high early strength Type III cement. Finally, although Type S is the preferred masonry cement, Type N and in some cases Type M, masonry cements can be used instead.

As noted previously, the cement constituents present in the cement component of the present invention can be provided by appropriate mixtures of three commercially available cements or two cements together with an added air entraining agent. A suitable formulation is one containing a Type I/II or a Type III Portland cement conforming to ASTM C 150, a pozzolanic material such as fly ash or a pozzolanic cement, such as Type IP cement conforming to ASTM C 595 and a masonry cement, such as Type S masonry cement, conforming to ASTM C 91. While the use of such commercially available cements provides a convenient and cost effective way of providing the preferred cement constituents, they can be supplied or supplemented by incorporating suitable additives. For example, in lieu of using a Type S masonry cement which provides an adequate air entraining factor, an air entraining agent such as that conforming to standards as set forth in ASTM C 260 can be employed. Such air entraining agents are well known to those skilled in the art and are described in the aforementioned Kosmatka et al publication, specifically Chapter 8 entitled, “Air Entrained Concrete,” the entire disclosure which is incorporated herein by reference. As described in Kosmatka et al., commercially available air entraining materials include vinsol wood resins, sulfonated hydrocarbons, fatty and resinous acides, aliphatic substituted aryl sulfonates, such as alkyl benzene sulfonates, sulfonated lignin salts and numerous other interfacially active materials which normally take the form of anionic or nonionic surface active agents. The ASTM Type IP cement can likewise be dispensed with, in lieu of fly ash or other suitable calcined pozzalonic material conforming to standard ASTM C 618. Thus, a single commercially available cement such as Type I, Type II or Type III cement conforming to ASTM C 150 can be used supplemented with appropriate additives as described above to arrive at the multi-constituent cement component employed in the present invention. The hydraulic cement component will normally in any case contain tricalcium silicate, dicalcium silicate, tricalcium aluminate, and tetracalcium aluminoferrite as described in greater detail previously.

As discussed earlier, the lightweight aggregate component employed in the present invention can be characterized as conforming to ASTM standard C 330 or C 331. As discussed, for example, in ASTM C 330, such aggregates are composed predominately of lightweight cellular and granular inorganic material which can be characterized as falling into two general classifications. One is usually in the form of expanded shale, clay or slate aggregates although they can be characterized generally as aggregates prepared by expanding, palletizing or sintering products such as blast furnace slag, clay diatomite, fly ash or clay, shale or slate as stated previously. Such aggregates can also include those prepared by processing natural materials such as pumice, scoria or tuff. As described in ASTM C 331, lightweight aggregates for masonry concrete include expanded, sintered products or natural products as described above and in addition include aggregates formed as end products of coal or coke combustion. Where such coal products are used, the aggregate can take the form of residual bottom ash into which fly ash has been introduced often as a pollution control measure. This same is true of other expanded lightweight aggregate such as those formed from expanded shale; so-called stack dust produced during the incineration procedure can be recirculated into the aggregate as a pollution control measure. Usually, as noted above, it will be preferred to provide aggregate having an avenge particle size of about ⅜ inch or smaller although such aggregates can comprise larger particles of a nominal size up to ¾ inch or in some cases up to 1 inch. The aggregate components are in any case, lightweight, usually friable particulate materials which have substantial pore spaces. Of course, the more porous and permeable the aggregate materials, the greater the amount of air which will be included into the concrete slurry as entrapped air, as distinguished from the entrained air, as discussed previously. For a further discussion of lightweight aggregates, reference is made to the aforementioned ASTM standards C 330 and C 331 and also to the aforementioned publication Lightweight Concrete by the Expanded Shale Clay and Slate Institute and particular, Section III entitled “What is Lightweight Aggregate?” at pages 14-17, the entire disclosures of which are incorporated herein by reference.

Having described specific embodiments of the present invention, it will be understood that modifications thereof may be suggested to those skilled in the art, and it is intended to cover all such modifications as fall within the scope of the appended claims.

1. A lightweight concrete composition comprising a dry mixture of:
(a) an aggregate component having a bulk density of no more than 75 lbs./ft³ present in said composition in an amount within the range of 55-70 wt. %;
(b) a hydraulic cement component present in an amount within the range of 30-45 wt. % and comprising the following constituents:
(i) a first cement constituent selected from a group consisting of Type I, Type II and Type III cements and mixtures thereof;
(ii) a second cement constituent comprising a pozzolanic material, present in an amount which is less than the amount of said first constituent;
(iii) a third cement constituent selected from the group consisting of Type S masonry cement, Type N masonry cement, Type M masonry cement, an air entraining agent and mixtures thereof, present in an amount which is less than the amount of said second cement constituent; and
(c) a fiber component comprising fibers having an aspect ratio within the range of 0.0015-0.0005, present in an amount providing a glass fiber equivalent weight percent of 2 wt. % or less of said concrete composition.

2. The lightweight concrete composition of claim 1 wherein said second cement constituent is selected from a group consisting of fly ash, Type C cement, Type F cement, and mixtures thereof.

3. The lightweight concrete composition of claim 2 wherein said first cement constituent comprises Type I/II cement.

4. The lightweight concrete composition of claim 1 wherein said fiber component is present in an amount providing a glass fiber equivalent weight percent of no more than 1 wt. % of said concrete composition.

5. The lightweight concrete composition of claim 1 wherein said fiber component is present in an amount providing a glass fiber equivalent weight percent of at least 0.4 wt. % of said concrete composition.

6. The lightweight concrete composition of claim 1 wherein said fiber component is present in an amount providing a glass fiber equivalent weight percent within the range of 0.4-0.7 wt. % of said concrete composition.

7. The lightweight concrete composition of claim 1 wherein said aggregate component is comprised predominantly of haydite.

8. The lightweight concrete composition of claim 1 wherein said aggregate component is present in an amount within the range of 58-66 wt. % and said cement component is present in amount within the range of 34-42 wt. %.

9. The composition of claim 1 wherein said aggregate component has a predominant particle size of 0.5 inch or less.

10. The lightweight concrete composition of claim 1 wherein said second cement constituent is present in an amount within the range of 70-90 wt. % of said first cement constituent.

11. The lightweight concrete composition of claim 10 wherein said third cement constituent is present in an amount within the range of 10-20 wt. % of said first cement constituent.

12. The lightweight concrete composition of claim 1 wherein the incremental difference between the amount of said first cement constituent and said second cement constituent is less than the incremental difference between the amount of said second cement constituent and said third cement constituent.

13. The lightweight concrete composition of claim 12 wherein said incremental difference between said second cement constituent and said third cement constituent is at least 3 times the incremental difference between said first cement constituent and said second cement constituent.

14. The lightweight concrete composition of claim 13 wherein the composite amount of said second cement constituent and said third cement constituent is equal to ±10% of the amount of said first cement constituent.

15. The lightweight concrete composition of claim 1 wherein said first, second and third cement constituents of said hydraulic cement component are present in fractional amounts of 0.5, 0.4, and 0.1, respectfully, of said hydraulic cement component.

16. The lightweight concrete composition of claim 15 wherein said second cement constituent comprises fly ash and said third cement constituent is selected from a group consisting of Type S masonry cement, Type N masonry cement and mixtures thereof.

17. The lightweight concrete composition of claim 1 wherein said third cement constituent comprises an air entraining agent which provides an air entraining factor for said composition of at least 4 vol. % when mixed with water in an amount within the range of 21-23 wt. % of said dry mixture.

18. The lightweight concrete composition of claim 1 wherein said fiber component comprises type AR glass fibers having a length particle size distribution predominantly within the range of ¼-½ inch.

19. The lightweight concrete composition of claim 18 wherein said glass fibers have a length predominantly within the range of ½-¾ inch.

20. The lightweight concrete composition of claim 1 wherein said fiber component is distributed predominantly within the hydraulic cement component of said composition.

21. A method of forming a fiber-reinforced lightweight concrete structure comprising:
(a) providing a cementitious composition comprising a mixture of
(i) an aggregate component having a bulk density of no more than 75 lbs./ft³ present in said composition in an amount within the range of 55-70 wt. %;
(ii) a hydraulic cement component present in an amount within the range of 30-45 wt. % and comprising the following constituents:
(1) a first cement constituent selected from a group consisting of Type I, Type II and Type III cements and mixtures thereof;
(2) a second cement constituent selected from a group consisting of fly ash, Type C or Type F cement or mixtures thereof, present in an amount which is less than the amount of said first constituent;
(3) a third cement constituent selected from the group consisting of Type S masonry cement, Type N masonry cement, Type M masonry cement, an air entraining agent and mixtures thereof, present in an amount which is less than the amount of said second cement constituent; and
(iii) a fiber component comprising Type AR glass fibers having an aspect ratio within the range of 0.0015-0.005, present in an amount of 2 wt. % or less of said concrete composition, said glass fibers being predominantly covered with said hydraulic cement component;
(b) mixing said cementitious composition with water in an amount to provide a cementitious slurry in which said glass fibers are dispersed predominantly within said hydraulic cement component as said hydraulic cement component is hydrated with said water; and
(c) applying said cement slurry to a working site and allowing said cement slurry to set to provide a structural mass in which said glass fibers are entrained within said structural mass.

22. The method of claim 21 wherein said first cement constituent comprises Type I/II cement.

23. The method of claim 21 wherein said cementitious slurry contains entrapped air in an amount which is greater than the entrapped air contained within a corresponding slurry of said aggregate component and said cement component, but without the presence of said fiber component.

24. The method of claim 21 wherein said second cement constituent comprises fly ash and said third cement constituent is selected from a group consisting of Type S masonry cement, Type N masonry cement and mixtures thereof.

25. The method of claim 24 wherein said first, second and third cement constituents of said hydraulic cement component are present in fractional amounts of 0.5, 0.4, and 0.1, respectfully, of said hydraulic cement component.
